(19) United States
(12) Patent Application Publication
(10) Pub. No.: US 2010/0246548 A1
(43) Pub. Date: Sep. 30, 2010

(54) BASE STATION, METHOD FOR MANAGING CELL, METHOD FOR DETECTION SIGNAL, TERMINAL AND METHOD FOR TRANSMITTING SIGNAL THEREOF

(75) Inventors: Seungjae Bahng, Deajeon (KR); Hoon Lee, Daejeon (KR); Youn Ok Park, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/730,804

(22) Filed: Mar. 24, 2010

(30) Foreign Application Priority Data
Mar. 24, 2009 (KR) 10-2009-0025103
Mar. 24, 2010 (KR) 10-2010-0026242

(51) Int. Cl. H04W 4/00; H04B 7/00

(52) U.S. Cl. 370/338; 455/509

(57) ABSTRACT

A base station according to an exemplary embodiment of the present invention includes: a receiver receiving environment information of a first terminal from the first terminal positioned at a cell boundary and receiving usable resource information from a neighbor base station; a resource allocator allocating a resource to the first terminal on the basis of the usable resource information; and a transmitter transmitting information on the resource allocated to the first terminal to the neighbor base station.

### CROSS-REFERENCE TO RELATED APPLICATION

This application claims priority to and the benefit of Korean Patent Application No. 10-2009-0025103 and 10-2010-0026242 filed in the Korean Intellectual Property Office on Mar. 24, 2009 and Mar. 24, 2010 the entire contents of which are incorporated herein by reference.

### BACKGROUND OF THE INVENTION

(a) Field of the Invention

The present invention relates to a base station, a method for managing a cell of the base station, a method for detecting a signal of a base station, a terminal, and a method for transmitting a signal thereof.

(b) Description of the Related Art

Users of approximately 30% are positioned at a cell boundary area in one sector of a mobile communication system. At this time, if a frequency reuse rate is 1, a terminal positioned at the cell boundary area may have its own performance depending on a geographical location, which is deteriorated and induce critical interference even in an uplink of a neighboring cell. In order to solve the problem, a fractional frequency reuse (FFR) method is being developed.

Meanwhile, resources in the mobile communication system generally mean a frequency and a time. In the case of using a multi input multi output (MIMO) antenna technology, a new spatial resource called a pilot pattern may be introduced in addition to the frequency and time. For example, in the case in which the number of receiving antennas in a base station is 4 and the number of transmitting antennas in a terminal is 1, 4 pilot patterns orthogonal to each other may exist. At this time, although 4 terminals use the same sub-carrier at the same time by using different pilot patterns, 4 different signals may be separated from each other in the base station having 4 receiving antennas and this is called collaborative spatial multiplexing (CSM).

### SUMMARY OF THE INVENTION

The present invention has been made in an effort to improve the performance of a terminal positioned at a cell boundary of a mobile communication system and prevent the terminal from operating as interference to a neighboring cell.

An exemplary embodiment of the present invention provides a base station that includes: a receiver receiving environment information of a first terminal from the first terminal positioned at a cell boundary and receiving usable resource information from a neighbor base station; a resource allocator allocating a resource to the first terminal on the basis of the usable resource information; and a transmitter transmitting information on the resource allocated to the first terminal to the neighbor base station.

The base station may further include a signal detector detecting a transmission signal of a second terminal from an entire reception signal including a first reception signal received from the first terminal and a second reception signal received from a second terminal positioned in a cell area.

The signal detector may remove interference caused due to the first terminal from the entire reception signal by using joint detection. The receiver may receive from the neighbor base station a signal removed with the interference caused due to the first terminal from the entire reception signal.

The base station may further include a signal combiner detecting the transmission signal of the first terminal by combining the signal removed with the interference and the reception signal from the first terminal.

The resource may include at least one of a time, a frequency, and a pilot pattern.

The environment information of the first terminal may include information on whether or not the first terminal is positioned at the cell boundary and information on the neighbor base station.

Another embodiment of the present invention provides a method for managing a first cell in a serving base station that includes: receiving from a first terminal positioned at the boundary between the first cell and a second cell managed by a neighbor base station information on whether the first terminal is positioned at the boundary and information on the neighbor base station; reporting a fact that the first terminal is positioned at the boundary to the neighbor base station; requesting information on a usable resource to the neighbor base station; receiving the information on the usable resource from the neighbor base station; and allocating the resource to the first terminal on the basis of the information on the usable resource.

The method may further include transmitting resource allocation information to the neighbor base station.

The method may further include: receiving a first reception signal from the first terminal; receiving as a fourth reception signal from the neighbor base station a signal acquired by removing a transmission signal of the second terminal from a second reception signal which the neighbor base station receives from the first terminal and a third reception signal which the neighbor base station receives from a second terminal included in the second cell; and detecting a transmission signal of the first terminal by combining the first reception signal and the fourth reception signal.

The resource may include at least one of a time, a frequency, and a pilot pattern.

Yet another embodiment of the present invention provides a method for detecting a transmission signal of a first terminal positioned in a cell managed by a first base station in the base station that includes: receiving information on a second terminal positioned at a cell boundary from a neighbor second base station; receiving a request for usable resource information from the second base station; transmitting the usable resource information to the second base station; receiving resource information allocated to the second terminal from the second base station; receiving a first reception signal from the first terminal and receiving a second reception signal from the second terminal; and detecting the transmission signal of the first terminal from the first reception signal and the second reception signal.

The detecting the transmission signal may further include removing interference caused due to the first terminal from the first reception signal and the second reception signal by using joint detection.

The method may further include transmitting the interference caused due to the first terminal to the second base station.

Still another embodiment of the present invention provides a terminal positioned at the boundary between a first cell managed by a first base station and a second cell managed by a second base station and receiving a service of the first base station that includes: an information transmitter transmitting environment information to the first base station; a receiver receiving a resource from the first base station in collaboration with the second base station; and a data transmitter transmitting data to the first base station by using the allocated resource.

The environment information may include information on whether the terminal is positioned at the boundary between the first cell and the second cell and information on the second base station.

The resource may include at least one of a time, a frequency, and a pilot pattern.

Still further another embodiment of the present invention provides a transmission method of a terminal positioned at the boundary between a first cell managed by a first base station and a second cell managed by a second base station and receiving a service of the first base station that includes: transmitting environment information to the first base station; receiving a resource from the first base station in collaboration with the second base station; and transmitting data to the first base station by using the allocated resource.

The environment information may include information on whether the terminal is positioned at the boundary between the first cell and the second cell and information on the second base station.

The resource may include at least one of a time, a frequency, and a pilot pattern.

### BRIEF DESCRIPTION OF THE DRAWINGS

FIG. 1 is a schematic diagram of a mobile communication system according to an exemplary embodiment of the present invention;

FIG. 2 is a diagram showing resources of a mobile communication system according to an exemplary embodiment of the present invention;

FIG. 3 is a block diagram of a resource management device according to an exemplary embodiment of the present invention;

FIG. 4 is a diagram showing one example of a resource allocated by a resource management device according to an exemplary embodiment of the present invention;

FIG. 5 is a block diagram of a terminal according to an exemplary embodiment of the present invention;

FIG. 6 is a flowchart showing transmission and reception procedures of a base station and a terminal according to an exemplary embodiment of the present invention; and

FIGS. 7 and 8 are graphs showing the performance of a mobile communication system according to an exemplary embodiment of the present invention and the performance of a known mobile communication system with a bit error rate (BER) for a signal to noise ratio (SNR), respectively.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising”, will be understood to imply the inclusion of stated elements but not the exclusion of any other elements. In addition, the terms “-er”, “-or” and “module” described in the specification mean units for processing at least one function and operation and can be implemented by hardware components or software components and combinations thereof.

In the specification, a terminal may designate a mobile station (MS), a mobile terminal (MT), a subscriber station (SS), a portable subscriber station (PSS), a user equipment (UE), an access terminal (AT), etc. and may include the entire or partial functions of the terminal, the mobile terminal, the subscriber station, the portable subscriber station, the user equipment, the access terminal, etc.

In the specification, a base station (BS) may designate an access point (AP), a radio access station (RAS), a node B, an evolved node B (eNodeB), a base transceiver station (BTS), a mobile multihop relay (MMR)-BS, etc. and may include the entire or partial functions of the access point, the radio access station, the node B, the evolved node B, the base transceiver station, the MMR-BS, etc.

Hereinafter, a base station, a method for managing a cell thereof, a method for detecting a signal thereof, a terminal, and a method for transmitting signal thereof according to an exemplary embodiment of the present invention will be described in detail with reference to the accompanying drawings.

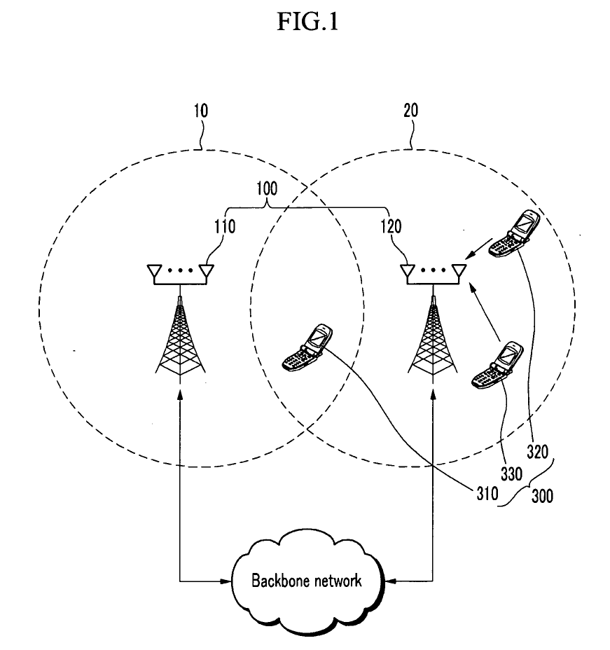

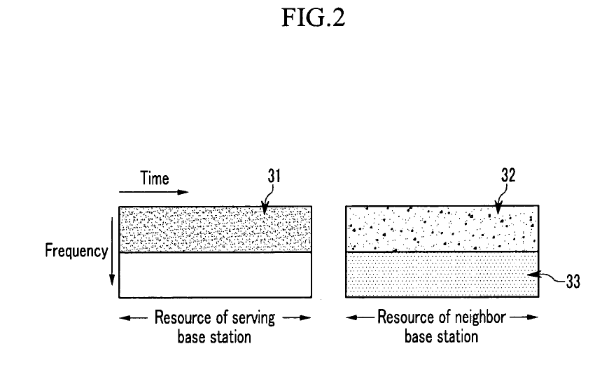

FIG. 1 is a schematic diagram of a mobile communication system according to an exemplary embodiment of the present invention and FIG. 2 is a diagram showing resources of a mobile communication system according to an exemplary embodiment of the present invention.

Referring to FIG. 1, the mobile communication system includes neighbor cells 10 and 20, a base station 100 and a terminal 300 that are present in the cells 10 and 20.

The terminal 300 includes a terminal 310 positioned at the boundary between the cells 10 and 20 and terminals 320 and 330 positioned in the cell 20.

The base station 100 allocates a resource to the terminal 300 and transmits and receives data to and from the terminal 300.

The base station 100 includes a base station 110 managing the cell 10 and a base station 120 managing the cell 20. The terminal 310 accesses the base station 110 and transmits and receives the data to and from the base station 110 and the terminal 320 and 330 access the base station 120 and transmit and receive the data to and from the base station 120. On the basis of the terminal 310 positioned at the boundary between the cells 10 and 20, the base station 110 is called a serving base station and the base station 120 is called a neighbor base station.

The serving base station 110 and the neighbor base station 120 transmit and receive signals to and from each other through a backbone network.

Referring to FIG. 2, frequencies used by the serving base station 110 and the neighbor base station 120 are the same as each other, while times used in the serving base station 110 and the neighbor base station 120 are different from each other. At the time used by the serving base station 110, the terminal 310 uses a fractional frequency 31. At the time used by the neighbor base station 120, the terminals 320 and 330 separately use different frequencies 32 and 33.

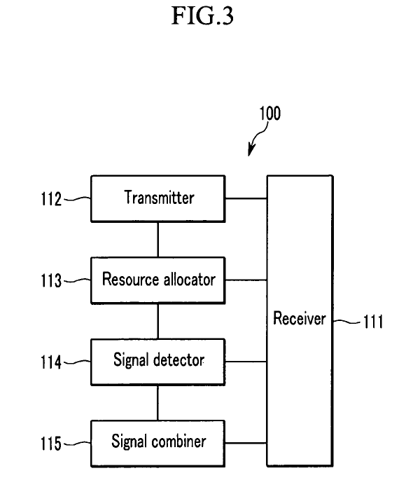

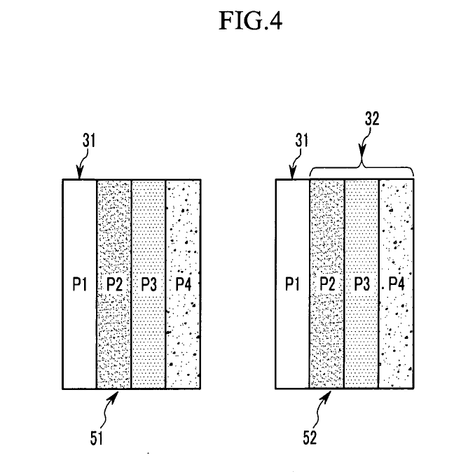

Hereinafter, the base station 100 according to an exemplary embodiment of the present invention will be described in detail with reference to FIGS. 3 and 4.

FIG. 3 is a schematic block diagram of a base station according to an exemplary embodiment of the present invention and FIG. 4 is a diagram showing one example of a resource allocated by a base station according to an exemplary embodiment of the present invention.

Referring to FIG. 3, the base station 100 includes a receiver 111, a transmitter 112, a resource allocator 113, a signal detector 114, and a signal combiner 115.

The receiver 111 receives information an environment of the terminal 310 from the terminal 310 positioned at the boundary between the cells 10 and 20. Herein, the information on the environment of the terminal 310 includes information on whether or not the terminal 310 is positioned at the cell boundary and information on the neighbor cell 20, that is, the neighbor base station 120.

The receiver 111 receives resource allocation information from the neighbor base station 120. Herein, the resource allocation information represents information on a usable pilot pattern other than a pilot pattern allocated to the terminal 320 using the same frequency as the terminal 310.

The transmitter 112 transmits the resource allocation information to the neighbor base station 120. The resource allocation information transmitted by the transmitter 112 represents information on the resource which the serving base station 110 allocates to the terminal 310.

The resource allocator 113 allocates the resource to the terminal 310 on the basis of the allocation information received from the neighbor base station 120. Herein, the resource includes the frequency, the time, and the pilot pattern.

In FIG. 4, an example 51 of pilot pattern allocation of the serving base station 110 and an example 52 of pilot pattern allocation of the neighbor base station 120 are shown. The serving base station 110 may allocate a pilot pattern p1 to the terminal 310 and the neighbor base station 120 may allocate any one of pilot patterns p2, p3, and p4 to the terminal 320 using the same frequency as the terminal 310. That is, since the terminal 310 influences both the serving base station 110 and the neighbor base station 120, both the serving base station 110 and the neighbor base station 120 manage the pilot pattern which the terminal 310 will use.

The signal detector 114 receives the signals from the terminal 310 positioned at the cell boundary and the terminal 320 positioned in the cell and then detects a transmission signal of the terminal 320 by removing the reception signal from the terminal 310. The signal detector 114 may use joint detection. That is, the signal detector 114 does not regard the signal from the terminal 310 positioned at the cell boundary as noise but performs signal detection by using the signal from the terminal 310 positioned at the cell boundary in addition to the signal received from the terminal 320 positioned in the cell on the basis of the known allocation information. Accordingly, the signal detection performance of the mobile communication system can be improved.

The signal combiner 115 detects the transmission signal of the terminal 310 by combining the signal received from the terminal 310 positioned at the cell boundary and the signal received from the neighbor base station 120. Herein, the signal received from the neighbor base station 120 is acquired when the neighbor base station 120 removes the reception signal from the terminal 320 positioned in the cell from the reception signal of the neighbor base station 120. A combining method of the signal combiner 115 may be maximal ratio combining (MCR).

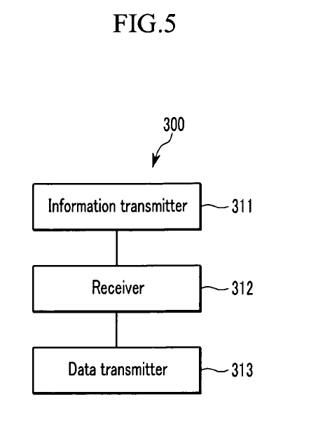

Hereinafter, the terminal according to an exemplary embodiment of the present invention will be described in detail with reference to FIG. 5.

FIG. 5 is a block diagram of a terminal according to an exemplary embodiment of the present invention.

Referring to FIG. 5, the terminal 300 includes an information transmitter 311, a receiver 312, and a data transmitter 313.

The information transmitter 311 transmits the environment information of the terminal 300 to the base station 100. Herein, the environment information includes information on whether the terminal 300 is positioned at the cell boundary and information on the neighbor cell. The terminal 300 receives and deciphers different preambles from the serving base station 110 and the neighbor base station 120 at the same time to acquire the environment information of the terminal 300.

The receiver 312 receives the resource allocation information from the base station 100. Herein, the resource allocation information represents a content that the serving base station 110 allocates the resource in collaboration with the neighbor base station 120.

The data transmitter 313 transmits the data to the base station 100 by using the allocated resource with reference to the resource allocation information received by the receiver 312.

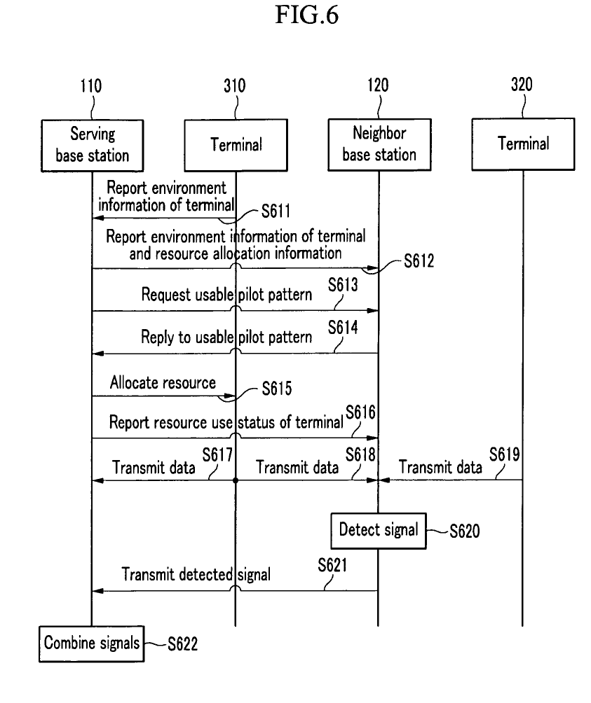

Hereinafter, a method for managing a cell of a base station, a method for detecting a signal, a method for transmitting signal of a terminal according to an exemplary embodiment of the present invention will be described in detail with reference to FIG. 6.

FIG. 6 is a flowchart showing transmission and reception procedures of a base station and a terminal according to an exemplary embodiment of the present invention.

Referring to FIG. 6, a terminal 310 position at a cell boundary reports environment information of the terminal to a serving base station 110 (S611). That is, the terminal 310 reports information on whether or not the terminal 310 is positioned at the cell boundary and information on a neighbor base station 120.

The serving base station 110 is reported about the terminal environment information from the terminal 310 and thereafter, reports the terminal environment information and resource allocation information to the neighbor base station 120 (S612). That is, the serving base station 110 reports the information that the terminal 310 is positioned at the cell boundary and information on a resource to be allocated to the terminal 310 to the neighbor base station 120. Herein, the resource includes a frequency, a time, and a pilot pattern.

In addition, the serving base station 110 requests information on a usable pilot pattern to the neighbor base station 120 (S613). Herein, the requested information is not limited to the usable pilot pattern and may be the time and the frequency.

Therefore, the neighbor base station 120 replies to the information on the usable pilot pattern for the serving base station 110 (S614).

The serving base station 110 determines the availability of the resource to be allocated to the terminal 310 on the basis of the information on the usable pilot pattern received from the neighbor base station 120 and thereafter, allocates the resource to the terminal 310 (S615). Subsequently, the serving base station 110 reports to the neighbor base station 120 that the terminal 310 transmits the data by using the allocated resource (S616).

Thereafter, the terminal 310 transmits the data (S617 and S618). Herein, the data transmitted by the terminal 310 is transmitted to the neighbor base station 120 as well as the serving base station 110.

Meanwhile, the neighbor base station 120 receives the data from a terminal 320 positioned in a cell 20 managed by the neighbor base station 120 in addition to the terminal 310 (S619).

Subsequently, the neighbor base station 120 detects a transmission signal of the terminal 320 on the basis of the signal received from each of the terminals 310 and 320 (S620). Thereafter, the neighbor base station 120 transmits to the serving base station 110 a signal acquired by removing the transmission signal of the terminal 320 from the signal received by the neighbor base station 120 itself (S621).

The serving base station 110 detects the transmission signal of the terminal 310 by combining the signal received from the terminal 310 and the signal received from the neighbor base station 120.

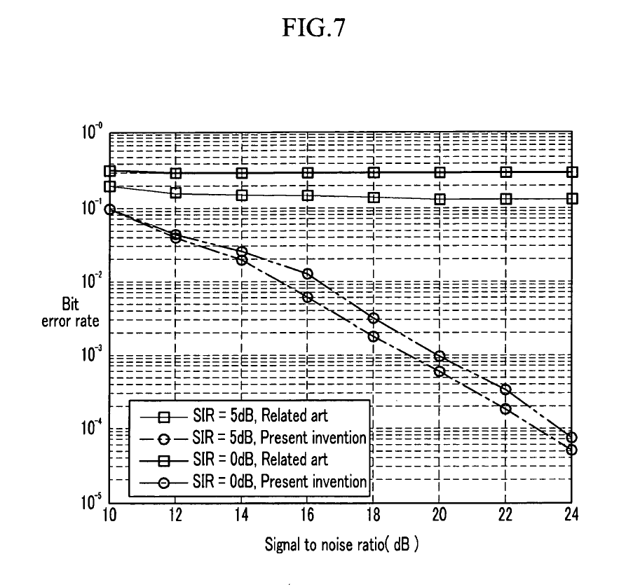

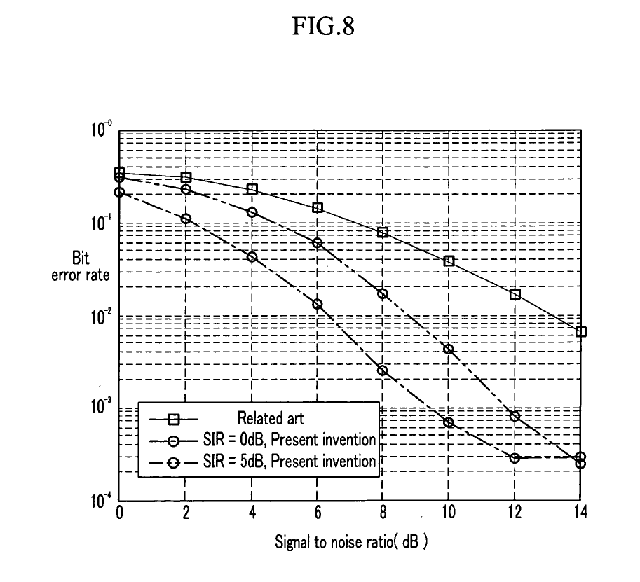

Hereinafter, an effect of the present invention will be described in detail with reference to FIGS. 7 and 8.

FIGS. 7 and 8 are graphs showing the performance of a mobile communication system according to an exemplary embodiment of the present invention and the performance of a known mobile communication system with a bit error rate (BER) for a signal to noise ratio (SNR), respectively.

In FIGS. 7 and 8, the mobile communication system according to the exemplary embodiment of the present invention assumed that the base station 100 has 2 reception antennas and the terminal 300 has 1 transmission antenna in the system shown in FIG. 1. Further, by considering an ITU Ped-A channel model, quadrature phase shift keying (QPSK) is used as a modulation method and 0 dB and 5 dB are considered as a signal to interference ratio (SIR) in the neighbor base station 120.

FIG. 7 shows the performance of the terminal 320 and FIG. 8 shows the performance of the terminal 310.

Referring to FIGS. 7 and 8, a bit error rate of the mobile communication system according to the exemplary embodiment of the present invention is lower than that of the known mobile communication system at the same signal to noise ratio. That is, when the resource is allocated to the terminal 310 positioned at the cell boundary in collaboration between the serving base station 110 and the neighbor base station 120, the performance of the mobile communication system is improved.

According to an embodiment of the present invention, a serving base station and a neighbor base station allocate resources used by terminals in collaboration with each other to thereby efficiently remove an interference effect caused due to a terminal positioned at a cell boundary and improve the performance of the terminal positioned at the cell boundary.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A base station, comprising:
a receiver receiving environment information of a first terminal from the first terminal positioned at a cell boundary and receiving usable resource information from a neighbor base station;
a resource allocator allocating a resource to the first terminal on the basis of the usable resource information; and
a transmitter transmitting information on the resource allocated to the first terminal to the neighbor base station.

2. The base station of claim 1, further comprising:
a signal detector detecting a transmission signal of a second terminal from an entire reception signal comprising a first reception signal received from the first terminal and a second reception signal received from a second terminal positioned in a cell area.

3. The base station of claim 2, wherein:
the signal detector removes interference caused due to the first terminal from the entire reception signal by using joint detection.

4. The base station of claim 3, wherein:
the receiver receives from the neighbor base station a first signal removed with the interference caused due to the first terminal from the entire reception signal.

5. The base station of claim 4, further comprising:
a signal combiner detecting the transmission signal of the first terminal by combining the first signal and the reception signal from the first terminal.

6. The base station of claim 1, wherein:
the resource comprises at least one of a time, a frequency, and a pilot pattern.

7. The base station of claim 1, wherein:
the environment information of the first terminal comprises information on whether or not the first terminal is positioned at the cell boundary and information on the neighbor base station.

8. A method for managing a first cell in a serving base station, comprising:
receiving from a first terminal positioned at the boundary between the first cell and a second cell managed by a neighbor base station information on whether the first terminal is positioned at the boundary and information on the neighbor base station;
reporting a fact that the first terminal is positioned at the boundary to the neighbor base station;
requesting information on a usable resource to the neighbor base station;
receiving the information on the usable resource from the neighbor base station; and
allocating the resource to the first terminal on the basis of the information on the usable resource.

9. The method of claim 8, further comprising:
transmitting resource allocation information to the neighbor base station.

10. The method of claim 9, further comprising:
receiving a first reception signal from the first terminal;
receiving as a fourth reception signal from the neighbor base station a signal acquired by removing a transmission signal of the second terminal from a second reception signal which the neighbor base station receives from the first terminal and a third reception signal which the neighbor base station receives from a second terminal included in the second cell; and
detecting a transmission signal of the first terminal by combining the first reception signal and the fourth reception signal.

11. The method of claim 8, wherein:
the resource comprises at least one of a time, a frequency, and a pilot pattern.

12. A method for detecting a transmission signal of a first terminal positioned in a cell managed by a first base station in the base station, comprising:
receiving information on a second terminal positioned at a cell boundary from a neighbor second base station;
receiving a request for usable resource information from the second base station;
transmitting the usable resource information to the second base station;
receiving resource information allocated to the second terminal from the second base station;
receiving a first reception signal from the first terminal and receiving a second reception signal from the second terminal; and
detecting the transmission signal of the first terminal from the first reception signal and the second reception signal.

13. The method of claim 12, wherein:
the detecting the transmission signal comprises removing interference caused due to the first terminal from the first reception signal and the second reception signal by using joint detection.

14. The method of claim 13, further comprising:
transmitting the interference caused due to the first terminal to the second base station.

15. A terminal positioned at the boundary between a first cell managed by a first base station and a second cell managed by a second base station and receiving a service of the first base station, comprising:
an information transmitter transmitting environment information to the first base station;
a receiver receiving a resource from the first base station in collaboration with the second base station; and
a data transmitter transmitting data to the first base station by using the allocated resource.

16. The terminal of claim 15, wherein:
the environment information comprises information on whether the terminal is positioned at the boundary between the first cell and the second cell and information on the second base station.

17. The terminal of claim 15, wherein:
the resource comprises at least one of a time, a frequency, and a pilot pattern.

18. A transmission method of a terminal positioned at the boundary between a first cell managed by a first base station and a second cell managed by a second base station and receiving a service of the first base station, comprising:
transmitting environment information to the first base station;
Receiving a resource allocation from the first base station in collaboration with the second base station; and
transmitting data to the first base station by using the allocated resource.

19. The method of claim 17, wherein:
the environment information comprises information on whether the terminal is positioned at the boundary between the first cell and the second cell and information on the second base station.

20. The method of claim 17, wherein:
the resource comprises at least one of a time, a frequency, and a pilot pattern.
